(19) United States
(12) Patent Application Publication
(10) Pub. No.: US 2015/0120430 A1
(43) Pub. Date: Apr. 30, 2015

(54) ELECTRONIC METHOD OF DELIVERING COUPONS

(71) Applicant: CDS WORLDWIDE PTY LTD, South Melbourne (AU)

(72) Inventor: Michael Eli Silberberg, South Melbourne (AU)

(21) Appl. No.: 14/528,284

(22) Filed: Oct. 30, 2014

(30) Foreign Application Priority Data
Oct. 30, 2013 (AU) 2013904192

(51) Int. Cl. G06Q 30/02

(52) U.S. Cl. CPC G06Q 30/0235
USPC 705/14.35

(57) ABSTRACT

An electronic method for providing electronic coupons to a user comprises receiving a user input of a parking request into a parking application running on a user's mobile device, the parking request being associated with a parking period. The method also comprises providing access to one or more electronic coupons via the parking application running on the mobile device in response to the parking request, enabling the user to redeem the one or more electronic coupons via the parking application, and expiring the one or more electronic coupons with the parking application so that the one or more electronic coupons are no longer redeemable via the parking application if the one or more electronic coupons are not redeemed within the parking period.

### BACKGROUND OF THE INVENTION

The invention relates to an electronic method of delivering coupons.

Coupons are used in marketing to encourage shoppers to purchase goods or services from participating advertisers.

One common method of delivering coupons is the use of the so-called “shopper docket” method where coupons are printed on receipts, for example, receipts from supermarkets.

The effectiveness of such techniques in reaching the target audience is hampered by the fact that they are delivered after the user has already finished shopping at the shop they are printed at.

Accordingly, there is a need for an alternative technique for delivering coupons to consumers.

### SUMMARY OF INVENTION

In a first aspect, there is provided an electronic method for providing electronic coupons to a user, the method comprising:

receiving a user input of a parking request into a parking application running on a user's mobile device, the parking request being associated with a parking period;

providing access to one or more electronic coupons via the parking application running on the mobile device in response to the parking request;

enabling the user to redeem the one or more electronic coupons via the parking application; and

expiring the one or more electronic coupons so that the one or more electronic coupons are no longer redeemable via the parking application if the one or more electronic coupons are not redeemed within the parking period.

In an embodiment, providing access to the one or more electronic coupons comprises delivering the one or more coupons to the parking application running the mobile device.

In an embodiment, the method comprises presenting a menu via the parking application, receiving a user selection via the menu of at least one category of coupons, and delivering one or more coupons corresponding to the at least one category.

In an embodiment, providing access to the one or more electronic coupons comprises, connecting the user to a coupon menu from which the user can select one or more coupons for delivery to the parking application running the mobile device.

In a second aspect, there is provided program code which when executed by a mobile device provides a parking application configured to:

receive a user input of a parking request, the parking request being associated with a parking period;

provide access to one or more electronic coupons in response to the parking request;

enable the user to redeem the one or more electronic coupons; and

expire the one or more electronic coupons so that the one or more electronic coupons are no longer redeemable via the parking application if the one or more electronic coupons are not redeemed within the parking period.

In an embodiment, the computer program code is provided on a tangible computer readable medium.

### BRIEF DESCRIPTION OF THE DRAWINGS

An embodiment of the invention will now be described in relation to the accompanying drawings in which:

FIG. 1 is a flow chart of a method of an embodiment of the invention; and

FIG. 2 is a block diagram illustrating of a parking and coupon system of an embodiment of the invention.

### DETAILED DESCRIPTION

Referring to the drawings, there is shown an electronic method for providing electronic coupons to a user. In the embodiment, the method involves receiving a user input of a parking request into a parking application running on the user's mobile device and, in response thereto, providing the user with access to one or more electronic coupons. In the embodiment, the coupons are expired if they are not redeemed within a parking period.

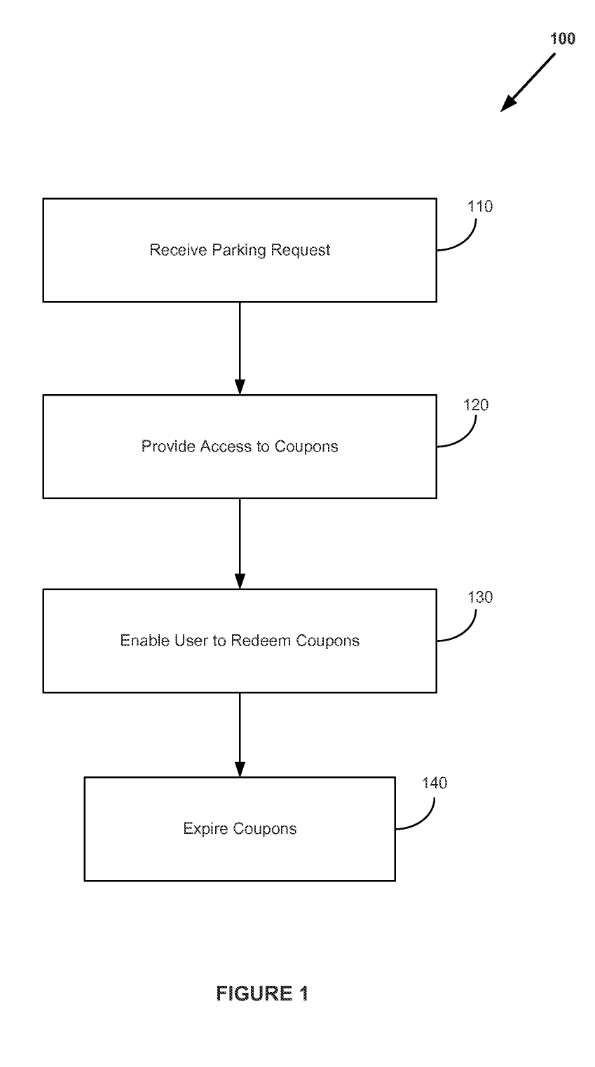

Referring to FIG. 1, there is shown a flow chart 100 of the embodiment. In a typical use case, a user arrives at a car park or a car parking space where payment can be made via a parking application running on the user's mobile phone device. In a typical use case, a user parks in a car parking space and enters details of the parking request into the parking application such as where they have parked based on information associated with their car parking space (e.g. on a sign or a meter box for accepting cash payments) and how long they intend to park. In an alternate embodiment, a fixed parking period may be prescribed such that the user only needs to enter where they have parked and the parking host system 280 can determine the parking period based on information identifying the car parking space. For example, if the information allows the parking host system 280 to determine that the user has parked in a two hour car parking space. In some embodiments, other details can be provided via the application to the host system 280 or pre-registered with the parking host system 280 such as the license plate of the user's vehicle. Once the user has completed details of their parking request 110, the user can be provided 120 with access to one or more electronic coupons via the parking application. Typically, this is achieved by the user being presented via the parking application with an option to select “yes” or “no” to the question “do you want to obtain coupons for this parking visit”. In one embodiment, when the user selects “yes”, one or more coupons are delivered by being transmitted to the user's mobile device and can then be accessed via the application. In one example, at least one of the coupons is automatically displayed by the application once they have been delivered and the user can operate their mobile device to browse through all the coupons, for example by scrolling or by swiping between coupons. In one embodiment, rather than a simple “yes/no”, the user may be able to specify a one or more categories in relation to which they want to receive coupons at that time. For example, the interface may have icons corresponding to “Clothes”, “Homewares”, “Dining”, “Entertainment”, and the user can operate the interface to select one or more may be able to select one or more categories. The host system then only delivers coupons in those categories.

In another embodiment, the user is provided with access to a menu from which they can select one or more coupons. For example, by connecting the user over the Internet to a website from which the user can select coupons in response to a “yes”. Such a website may incorporate a search facility in order to assist the user to locate coupons in which they are interested.

During the parking period, the user is able to redeem 130 the one or more electronic coupons via the parking application. For example, by displaying the coupon to a retailer. The coupon may include an electronically readable code, e.g. a bar code, that is scanned in by the retailer. When the parking period ends, the electronic coupons are expired 140 so that they are no longer redeemable via the parking application. In this way, the coupons are only available during the time period when a user is parked in the car park and cannot be used by users that are not using the parking application.

An advantage of the above method is that it allows advertisers to deliver targeted coupons to users based on the physical location associated with the car park before they commence shopping while controlling the time period in which the user can redeem them.

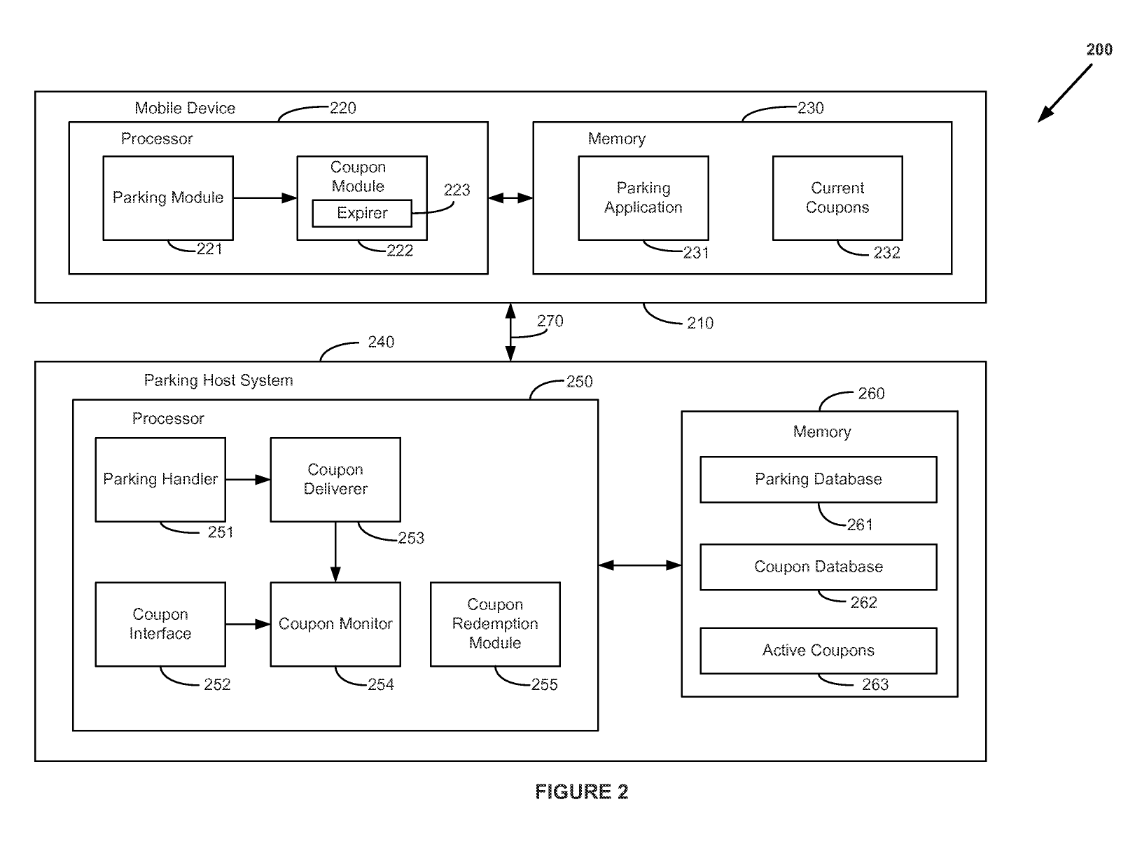

Referring to FIG. 2, there is an example of a parking system of an embodiment. In the parking system 200, a user's mobile device has downloaded a parking application 231 which is resident in memory 230 of the mobile device. When executed by the processor 220 of the mobile device, this parking application instantiates a parking module 221. The user interacts with the interface of parking module 221 to initiating a parking session. For example, by entering an identification number associated with the parking space and a desired parking period. The user's request for a parking session is communicated over a communication network 270 (such as the Internet) to a parking host system 280. At the parking host system 240, processor 250 implements a number of modules 251 to 255 based on program code stored in memory 260. These include a parking handler 251 which receives that parking request and confirms back to the mobile device parking module 221 that a parking session has been successfully initiated. In embodiments, where the user does not need to enter the requested parking period, the parking handler 251 may look up the parking period that applies in respect of the parking request. The parking handler 251 may also undertake other actions such as determining that the parking request is valid. The memory 260 of the parking host system has a parking database 261 that is updated by the parking handler 251 in order to maintain a record of the parking session. When the parking module 221 receives confirmation that the parking session has been initiated it outputs to the user the details of the parking session which may include the length of the parking period. In an embodiment, the parking module 221 then presents to the user an option to initiate a coupon module 222 by displaying a message requesting the user to indicate via the application whether they wish to receive coupons in respect of this parking session. Persons skilled in the art will appreciate that this can also be configured by preferences stored in the parking application. For example, that the user wishes to receive coupons in respect of particular parking sessions and not other parking sessions. For example, the user may wish to receive coupons except when parking in the car park that they use near their work place. Alternatively, the user may wish to indicate whether they wish to receive coupons each time they use the application.

As indicated above, the coupon module 222 can operate in two modes and indeed different modes may be activated depending on the car park. For example, a car park located in the center of the city may operate in a different mode to a car park at a major shopping center.

In one embodiment, the coupon module 222 advises the parking host system 250 that the user wishes to receive coupons. In this embodiment, the coupon deliverer 253 examines the coupon database 262 and determines what coupons to deliver to the user. Coupons may be linked to the particular car park in which the user has parked and/or they may be determined based on user behavior and/or user preferences registered with the system.

In this respect, the user will typically have an account with the system in order to be able to make parking requests and hence user behavior data can be gathered over time and stored in association with the user account.

Having determined what coupons to deliver, the coupon deliverer 253 then delivers the coupons to the coupon module 222 where they can be displayed to the user and adds them to the active coupons 263. The coupon module creates a record of the current coupons 233 stored in memory 230 of the mobile device. The coupon module 222 also includes a coupon expirer 223 which is arranged to expire the coupons at the end of the parking period. In one embodiment, the coupon expirer 223, expires the coupons by automatically deleting them from memory upon determining that the parking period has expired or at a defined delay after expiry of the parking period. In another embodiment, the coupon expirer 223, changes a status of the coupons in the memory to indicate that they have expired. In one embodiment, when a parking request is made, the coupon expirer monitors the parking period by starting a clock or a timer to monitor the parking period and uses the value of the clock or timer to initiate the process of expiring the one or more coupons.

In one embodiment, the parking period is communicated from the parking module 221 to the coupon module 222 during initiation of the parking session. In another embodiment, the parking period associated with the parking request can be determined at the end of the user's parking stay. For example, by the user confirming that they have completed their parking visit by entering data into the parking module. In such an embodiment, the parking module 221 advises the coupon module 222 that the parking session has terminated and the coupons should be expired.

As indicated above, in some embodiments, the user may be able to select their coupons. To this end, a coupon interface 252 is provided by the parking host system 240 that has a menu that enables a user to select coupons or categories of coupons to receive. It will be appreciated that different interfaces may be provided for different parking venues. The coupon interface 252 may be configured to control the number of coupons that are selected.

The parking host system 240 also has a coupon monitor 254 which monitors which coupons are active coupons 263 and also acts to expire the active coupons 263 within the database in the same way that they are expired on the user's device. In another embodiment, the coupons may be initially expired at the host system by the coupon monitor 254 (e.g. by changing a status of a coupon within the memory storing the database) and the host system may communicate with the mobile device to cause the mobile device to expire the coupons.

The parking host system also has a coupon redemption module 255 which when the user presents the coupon by presenting their mobile device to a participating retailer can be accessed over the internet (either via the retailer or via the user's mobile device) in order to redeem the coupon. Once the coupon has been redeemed, it is removed from the active coupon database 263. The memory 260 of the parking host system may also keep records of redeemed coupons as this may be used to determine the effectiveness of the system or form part of the calculation of fees to be paid by participating retailers.

Further aspects of the method will be apparent from the above description of the system. It will be appreciated that at least part of the method will be implemented electronically, for example, digitally by a processor executing program code. For example, in the above description certain steps are described as being carried out by the parking host system. It will be appreciated that these steps will be carried out by software executed by one or more processors, for example using an appropriately configured computer server. It will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art, will appreciate that program code provides a series of instructions executable by the processor.

Herein the term “processor” is used to refer generically to any device that can process instructions and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention; in particular it will be apparent that certain features of embodiments of the invention can be employed to form further embodiments.

For example, in another embodiment, the parking application may be used to gain entry to a car park, for example, by displaying a optically readable code (e.g. a QR code) to a code reader at the entry to the car park as described in Australian provisional application number 2013904152 filed on 28 Oct. 2013 by the present applicant, the disclosure of which is incorporated by reference. The presentation of the QR code can constitute the parking request and coupons can be delivered automatically to the user's device via the parking application. Such a technique may suit users who permanently park in a car park or who have pre-booked a car parking space. In such an embodiment, presentation of a QR code to leave the car park can define the end of the parking period.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. An electronic method for providing electronic coupons to a user, the method comprising:
receiving a user input of a parking request into a parking application running on a user's mobile device, the parking request being associated with a parking period;
providing access to one or more electronic coupons via the parking application running on the mobile device in response to the parking request;
enabling the user to redeem the one or more electronic coupons via the parking application; and
expiring the one or more electronic coupons so that the one or more electronic coupons are no longer redeemable via the parking application if the one or more electronic coupons are not redeemed within the parking period.

2. A method as claimed in claim 1, wherein providing access to the one or more electronic coupons comprises delivering the one or more coupons to the parking application running the mobile device.

3. A method as claimed in claim 2, comprising presenting a menu via the parking application, receiving a user selection via the menu of at least one category of coupons, and delivering one or more coupons corresponding to the at least one category.

5. A method as claimed in claim 1, wherein providing access to the one or more electronic coupons comprises, connecting the user to a coupon menu from which the user can select one or more coupons for delivery to the parking application running the mobile device.

6. A tangible computer readable medium comprising computer program code which when executed by a mobile device provides a parking application configured to:
receive a user input of a parking request, the parking request being associated with a parking period;
provide access to one or more electronic coupons in response to the parking request;
enable the user to redeem the one or more electronic coupons; and
expire the one or more electronic coupons so that they are no longer redeemable via the parking application if they are not redeemed within the parking period.
